(19) United States
(12) Patent Application Publication
(10) Pub. No.: US 2007/0139300 A1
(43) Pub. Date: Jun. 21, 2007

(54) Electronic brush position detection

(75) Inventors: Bart A. Salters, Eindhoven (NL); Marcel P.C.M. Krijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/580,064

(22) PCT Filed: Nov. 19, 2004
(86) PCT No.: PCT/IB04/52493

§ 371 Date: May 22, 2006

Related U.S. Application Data
(60) Provisional application No. 60/524,586, filed on Nov. 24, 2003.

(51) Int. Cl. G09G 5/00

(52) U.S. Cl. 345/3.3

(57) ABSTRACT

The invention provides a method of activating an electronic paint (10). A first embedded position marker (20) in a first portion (14) of an image (12) written onto a first portion of the electronic paint (10) is scanned. A position of an electronic brush (30) is determined based on the scanned position marker (20). Image data is modified to embed a second position marker (26) in a second portion (16) of the image (12) based on the determined position of the electronic brush (30). The second portion (16) of the image (12) including the second position marker (26) is written onto a second portion of the electronic paint (10).

This invention relates generally to electronic-paint activation, and more specifically to a method and a system for writing an image onto electronic paint with an electronic brush.

Research into reflective or paper-like displays encompasses several technologies related to electrophoretic image displays (EPID) and suspended particle displays (SPD). These displays, which are characterized by being non-luminescent and viewable under ambient light alone, hold promise for applications such as large signage, billboards and posters that need to be updated only infrequently, with days or even weeks and months between updates.

Electrophoretic displays, for example, are activated to write a desired image onto its surface, which comprises electronic ink, also referred to as digital ink. Encapsulated, electrophoretic materials for thin electronic-ink displays can be more than six times brighter than reflective liquid-crystal displays (LCDs) and can be seen at any angle without a change in contrast, unlike LCDs. This, in part, is the reason why electronic-ink applications are attractive for portable applications such as laptop computer screens, cell phones, and personal digital assistants (PDAs) that require low power consumption.

Electrophoretic displays can be bistable, in that their display elements have first and second display states that differ in at least one optical property such as lightness or darkness of a color. In recent electrophoretic displays, changes in the display occur after microencapsulated particles in the electronic ink have been driven to one state or another by means of an electronic pulse of a finite duration, and the last display state persists after the voltage has been removed.

The surface of an exemplary display comprises a thin electrophoretic film with millions of tiny microcapsules in which positively charged white particles and negatively charged black particles are suspended in a clear fluid. When a negative electric field is applied to the display, the white particles move to the top of the microcapsule where they become visible to the user. This makes the surface appear white at the top position or surface of the microcapsule. At the same time, the electric field pulls the black particles to the bottom of the microcapsules where they are hidden. When the process is reversed, the black particles appear at the top of the microcapsule, which makes the surface appear dark at the surface of the microcapsule. When the activation voltage is removed, a fixed image remains on the display surface. Before another image is written, the so-called electronic ink of the display material may need to be reset to a well-defined state, such as an all white surface with white particles moved to the top of the microcapsules, prior to re-addressing the ink. This can be accomplished by, for example, applying a relatively high voltage across front and rear electrodes of the display, forcing the ink into one state through the applied electric field. In other types of

electrophoretic displays, a photoconductive layer sandwiched with the encapsulated electrophoretic materials between the front and rear electrodes is irradiated to write an image while an activation voltage is applied.

Digital- or electronic-ink technology for large electronic wall displays may be applied to so-called electronic wallpaper, poster or wall screen, which consist of a thin film placed on a large flat surface. Electronic paint, the application of electronic-ink or similar technologies to large displays, would be appropriate where semi-permanent images are required, such as a large electronic advertisement medium. This low-cost electronic paint application could be used, for example, to put a picture, photograph, text or other information on a wall or a similar surface.

Currently available electrophoretic image displays are often addressed using direct drives whereby every pixel is directly connected to a dedicated output of the drive electronics, or are addressed by using column or row addressing schemes. These active-matrix techniques, however, are not an attractive option for inexpensive billboard-like displays, which require only a low to extremely low refresh rate. Most electronic-paint systems that are being developed for large electrophoretic displays have no intrinsic addressing schemes, such as fixed coordinates on a pixel-by-pixel grid, to accurately write text and graphics. The display surfaces preferably do not have any kind of driving electronics, thus enabling low-cost, large-area solutions.

Methods, systems and related devices for addressing and writing to electronic-ink displays are beginning to be introduced in smaller electrophoretic displays. Exemplary handheld personal computers, PDAs, or web-enabled mobile phones generate data by a user writing and drawing on a touch-sensitive screen of the device, or on a writing tablet with a stylus or other pointing device. Other handheld devices have been designed to transfer computer-generated data onto paper. For example, a handheld inkjet printing apparatus with a scanner prints directly onto a surface is described in “Printer Apparatus,” Johnstone et al., AU746703 issued May 2, 2002. Such a printer might use marks along a writing surface to synchronize location of print operations, as disclosed in “Printer Integral with a Manually Displacable Casing,” Simonin, FR2592337 issued Jul. 3, 1987. Methods have been developed to embed hidden information like digital watermarks and digital fingerprints into an image that is printed on paper, as seen in “Watermarking with Random Zero-Mean Patches for Printer Tracking,” Ratnaker, U.S. Pat. No. 6,556,688 issued Apr. 29, 2003. In addition, the printer can generate and provide to a remote controller signals that represent printer speed of movement over a surface, as described in “Hand-Held Printing Apparatus,” Cross, EP0036295 published Sep. 23, 1980.

Addressing systems for printing single sheets of paper do not solve the additional alignment and addressing problems with transferring data such as images or text to a large and variably sized display material, such as on a wall. While the aforementioned addressing systems may be feasible for small or large, expensive applications, an addressing system without electronic-driven paint surfaces is desirable for large, inexpensive wall or signage displays. An addressing device for electronic paint on a wall needs to be able to write to or locally activate the electronic paint The addressing device should be able to store the image or text that is being conveyed to the display, as well as be able to determine the location of the device in relation to the display surface.

Transferring data such as a large picture or image to electronic paint on a wall requires a method for aligning strokes of a handheld device when multiple strokes over the wall are needed. For example, a one-meter by one-meter display may require at least ten different strokes of a handheld device that has a 10-centimeter long addressing mechanism, in much the same way that any wall being painted requires multiple strokes with a paint roller. Generating a display with electronic paint requires a process whereby the position of the input device can be determined accurately and multiple strokes over the surface of the electronic paint do not cause alignment artifacts of the device.

In light of the discussion above, an effective, relatively inexpensive system and associated electronic output device are needed to overcome the abovementioned challenges and obstacles related to controlling and transferring data to a surface of a large electronic-paint wall display without alignment and problems typically associated with multiple strokes of an output device. In addition, the desirable system would not require that extra hardware or devices be attached to a display surface. Thus, the desirable system, method, and associated electronic input device are able to control and transfer digital image data to an electronic-paint display without alignment artifacts from multiple strokes of the device.

One aspect of the invention is a method of activating an electronic paint. A first position marker embedded in a first portion of an image written onto a first portion of an electronic paint is scanned. A position of an electronic brush is determined based on the scanned position marker. Image data is modified to embed a second position marker in a second portion of the image based on the determined position of the electronic brush, and a second portion of the image including the second position marker is written onto a second portion of the electronic paint.

Another aspect of the invention is a system for activating an electronic paint, including means for scanning a first embedded position marker in a first portion of an image written onto a first portion of an electronic paint, means for determining a position of an electronic brush based on the scanned position marker, means for modifying image data to embed a second position marker in a second portion of the image based on the determined position of the electronic brush, and means for writing the second portion of the image with the second position marker onto a second portion of the electronic paint.

Another aspect of the invention is an electronic brush for activating an electronic paint. The electronic brush includes an electronic-brush housing, an electronic-paint activation device coupled to the electronic-brush housing, an electronic-brush scanner coupled to the electronic-brush housing, and a controller in electrical communication with the electronic-paint activation device and the electronic-brush scanner. A position of the electronic brush is determined based on at least one embedded position marker in a first portion of an image written onto a first portion of an electronic paint that is scanned by the electronic-brush scanner and communicated to the controller. An electronic-paint write signal is sent from the controller to the electronic-paint activation device based on the determined electronic-brush position.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

Various embodiment of the present invention are illustrated by the accompanying figures, wherein:

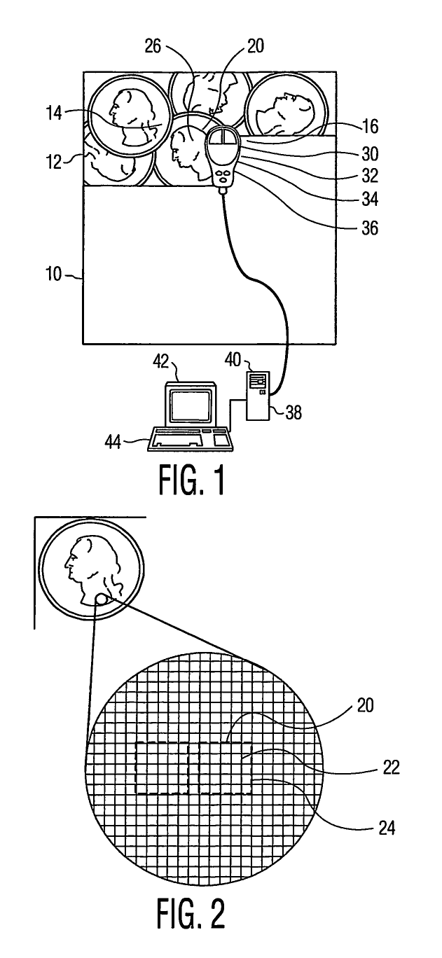

FIG. 1 is an illustration of a system for activating an electronic paint including an electronic brush, in accordance with one embodiment of the current invention;

FIG. 2 is an illustration of an embedded position marker, in accordance with one embodiment of the current invention;

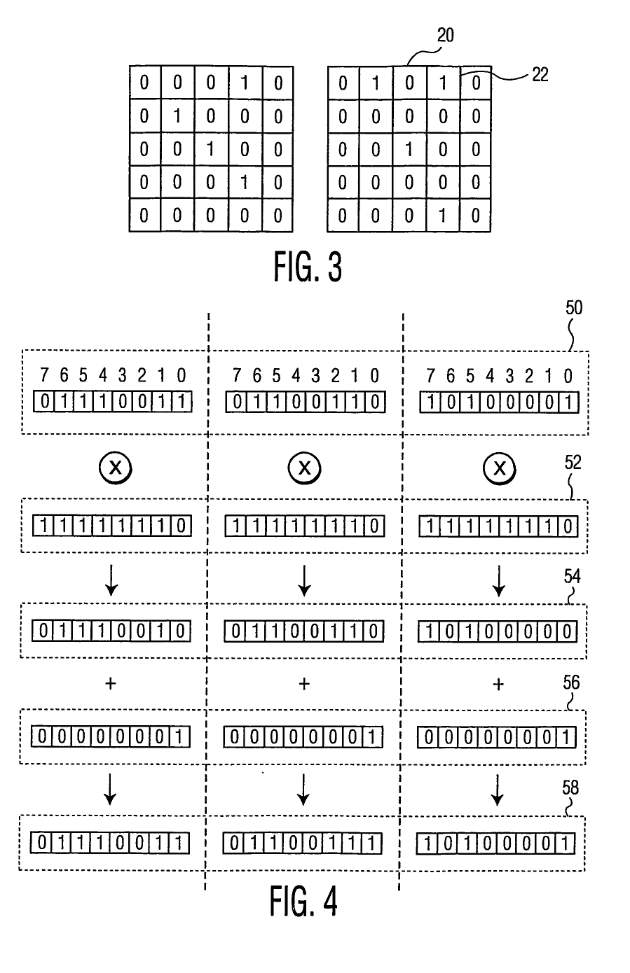

FIG. 3 is an illustration of a pair of position markers, each with a 5×5 block of position-marker elements, in accordance with one embodiment of the current invention;

FIG. 4 illustrates a method for activating an electronic paint, showing unmodified image data and modified image data corresponding to an image pixel within an embedded position marker for the exemplary system of FIG. 1, in accordance with one embodiment of the current invention;

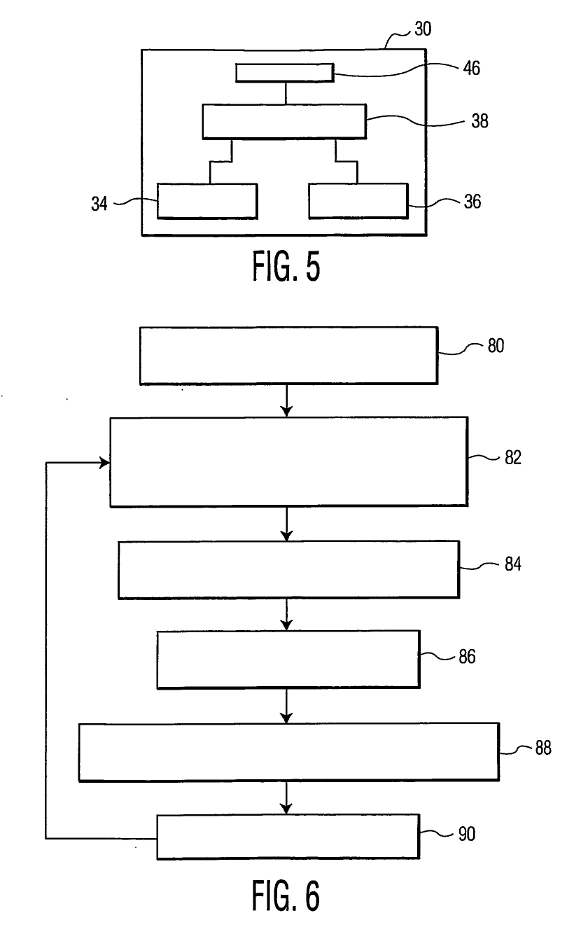

FIG. 5 is a block diagram of a system for activating an electronic paint, in accordance with one embodiment of the current invention; and

FIG. 6 is a flow chart of a method for activating an electronic paint, in accordance with one embodiment of the current invention.

FIG. 1 illustrates a system for activating an electronic paint including an electronic brush, in accordance with one embodiment of the present invention. An image 12 is written onto an electronic paint 10 such as an electrophoretic display or a photosensitive electrophoretic material using an electronic brush 30. Image 12 includes, for example, a picture, a photograph, text, an illustration, a graphic, or other image material that can be written onto electronic paint 10. As electronic brush 30 is stroked across electronic paint 10, the image is written by activating electronic paint 10 with an electronic-paint activation device 34 within electronic brush 30. To accurately write image information onto electronic paint 10, knowledge of the position including the location and rotation of electronic brush 30 is needed, particularly to stitch together image information with consecutive strokes of electronic brush 30. When electronic brush 30 is placed against the surface of electronic paint 10, the position of electronic brush 30 is determined by scanning at least one embedded position marker 20 in a first portion 14 of image 12 written onto electronic paint 10. Position markers 20 comprising, for example, a plurality of adapted pixels within activated electronic paint 10, provide electronic brush 30 with the capability to determine the location and rotation of electronic brush 30 so that additional image data can be written onto electronic paint 10. To determine the position of electronic brush 30, a first embedded position marker 20 is scanned with an electronic-brush scanner 36. Image data for image 12 is modified to embed additional position markers 26 in a second portion 16 of image 12, which is written as electronic brush 30 is stroked across the surface of electronic paint 10.

Electronic brush 30 includes an electronic-brush housing 32, an electronic-paint activation device 34 coupled to electronic-brush housing 32, and electronic-brush scanner 36 coupled to electronic-brush housing 32. A controller 38 residing in either electronic brush 30 or externally to electronic brush 30 such as in a computer 40 is in electrical communication with electronic-paint activation device 34 and electronic-brush scanner 36. Controller 38 may be wired or wirelessly connected to electronic-paint activation device 34 and electronic-brush scanner 36 using, for example, a standard wireless communication protocol such as Bluetooth or Wi-Fi. Output signals from electronic-brush scanner 36 are communicated to controller 38, and electronic-paint write signals are sent from controller 38 to electronic-paint activation device 34 based on the electronic-brush position.

Electronic-brush housing 32, shown with a profile similar to an electronic or optical mouse, may be shaped as a pad, a wand, a brush, or other suitable form. Electronic-paint activation device 34 writes onto electronic paint 10 with variable intensity by using a scanned laser driver, a matrix of electrodes for generating an electric field locally within electronic paint 10, or other suitable technique for transferring image data onto electronic paint 10. In one approach, a voltage is applied across the front and back electrodes of an electrophoretic display, and a laser scanner coupled to electronic-brush housing 32 locally changes the conductivity of a photoconductor sandwiched between the electrodes, thereby causing the encapsulated electrophoretic material to change state as desired.

Electronic-brush scanner 36 may comprise a one- or two-dimensional optomechanical scanner, an array of one-dimensional solid-state scan bars, one or more imaging arrays such as a CMOS light detector array or a digital camera, or other types of scanning mechanisms. The field of view for electronic-brush scanner 36 is sufficiently large to detect at least one embedded position marker 20, and may be large enough to scan two, three, or more embedded position markers 20 from which accurate location and rotation information can be derived. Two or more spaced-apart electronic-brush scanners 36 may be coupled to electronic-brush housing 32 to increase accuracy in determining the location and rotation of electronic brush 30. Color filters (not shown) may be placed in front of electronic-brush scanner 36 to extract position-marker information from individual colors comprising the image pixels. Controller 38 may be a central processing unit (CPU), a dedicated controller, or other suitable electronic circuit such as a field-programmable gate array (FPGA) with an embedded processor.

An electronic-paint image writing application used to transfer image data onto electronic paint 10 may be run within electronic brush 30 or within computer 40 such as a personal computer (PC), a personal digital assistant (PDA), a laptop computer, or an Internet-enabled digital device coupled to electronic brush 30. For example, the electronic-paint image writing application is used to display image 12 on a computer display 42 connected to computer 40 prior to writing the image information onto electronic paint 10. Functions and features for writing image 12 onto electronic paint 10 are selected by using an input device 44 such as a keyboard or a keypad.

FIG. 2 shows an illustration of an embedded position marker, in accordance with one embodiment of the current invention. Position marker 20 comprises, in one example, an array or block of position-marker elements 22 within a position-marker perimeter 24. In the example illustrated, position marker 20 includes a five-by-five block of position-marker elements 22, with a separation or a guard band between position marker 20 and an adjacent position marker. Alternatively, other configurations such as a four-by-four array, a larger block, a one-dimensional strip, or a rectangular array of position-marker elements 22 can be used. Each position-marker element 22 may be coded with one of two states, providing up to 33 million distinct position codes for a five-by-five array, or over 65,000 distinct position codes for a four-by-four array. For example, an image with 1000 by 1200 image pixels would require as few as 48,000 position markers 20 when each position marker 20 contains a block of 25 position-marker elements 22 with one image pixel in each element and with no guard bands. In cases where two or more image pixels are included in each position-marker element 22, the number of position markers 20 required would be reduced.

Embedded position markers 20 are often small. For example, with a forty centimeter by forty-eight centimeter display, each position-marker element 22 that comprises one image pixel would be 40 micrometers long. Furthermore, the embedded position markers 20 may be nearly invisible to the naked eye. Known scanners with sufficiently sensitive detectors can pick up variations in written image intensity that are finer than what can be seen with the unassisted human eye, allowing small, unseen modifications and alterations to the written image data. These modifications and alterations, when detected may be used to determine the location and rotation of the electronic brush for writing additional portions of the image.

FIG. 3 illustrates a pair of position markers, each with a five-by-five block of position-marker elements, in accordance with one embodiment of the present invention. The zeros and ones in position-marker elements 22 correspond to states in the lowest bit plane of the image data. The bit plane includes, for example, the least significant bit (LSB) or a least significant bit block of two or more least significant bits representing the color and intensity of image pixels in each position-marker element 22. Each position marker 20 contains a predefined code corresponding to the location on the electronic paint where position marker 20 will be written or is currently located. In one example, position-marker elements 22 comprise an unmodified area when position marker 20 is cleared, and a darker area than the original image when position marker 20 is set, such as is obtained when the image data at that location is incremented by a predetermined amount of one least significant bit or more. Alternately, position-marker elements 22 comprise an unmodified area when position marker 20 is cleared, and a lighter area than the original image when position marker 20 is set, based on whether a high value of 255 for an exemplary eight-bit color representation produces a dark or a light pixel and whether the display is emissive, transmissive, or reflective. In another example, position-marker elements 22 comprise an unmodified area when position marker 20 is cleared, and a darker area or a lighter area than the original image when position-marker element 22 is set such as is obtained when the image data at that location is flipped in the least significant bit position from a one or odd number to a zero or an even number or vice versa. In another example, position-marker elements 22 comprise an unmodified area or a lighter area than the original image when position-marker element 22 is cleared, and a darker area or an unmodified area when position-marker element 22 is set, such is obtained when the image data representing the image intensity is first cleared or set to zero in one or more least significant bit positions. More contrast can be obtained between position-marker element states by incrementing, decrementing, or clearing two or more least significant bits in the image data. Image data can be adjusted, for example, in gray scale for black-and-white image writing, and in one, two, three, or all colors when color image writing onto the electronic paint.

In other variations of embedded position marker 20, the modified areas can be selected to ensure that the perimeter of embedded position marker 20 is readily determined. For example, the perimeter of the embedded position marker 20 can be determined by setting only one position-marker element 22 along each row or column just inside the position-marker perimeter to a set state. Alternatively, embedded position marker 20 can be determined by setting the corner elements to a set state and all other position-marker elements 22 that are adjacent to the embedded position-marker perimeter to a cleared state. Alternatively, the states in a guard band between adjacent position markers 20 can be set or cleared in a predetermined manner to aid in locating position markers 20 and to determine the location of position marker 20 within the image.

The modified areas may be selected so that the orientation of embedded position marker 20 is able to be determined. For example, three corners out of four within position marker 20 can be set and the remaining corner cleared, with the cleared corner indicating the direction towards the upper left corner of the electronic-paint surface.

Other codes can be applied to position-marker elements 22, such as redundant codes, randomized codes, Gray codes, error-correcting codes, codes with a checksum, or codes that directly represent the x and y position such as a decimal or binary-encoded number. It should be observed that some algorithms for detecting embedded position markers 20 require knowledge of the original, unmodified image data being deciphered, whereas other algorithms do not require access to the original image data to determine position-marker location and rotation.

FIG. 4 is an illustration of unmodified image data and modified image data corresponding to an image pixel within an embedded position marker, in accordance with one embodiment of the present invention. Modifications to the image data are based on calculations and manipulations of pixel information. The modified image data generated in this depiction does not require access to the original image data to determine the location of the position marker. Although presented for a colored image pixel comprising magenta, yellow and cyan, the algorithm used in this illustration proceeds similarly with comparable results for black-and-white images or for individual color components.

Unmodified image data 50 represents color component information for an exemplary image pixel in one position-marker element within a position-marked region of an image to be written onto the electronic paint. Color image pixel information is represented in this example for magenta, yellow and cyan, with the least significant bit shown on the right of each eight-bit representation. A position-marker mask 52 is used to clear least significant bits from unmodified image data 50. In the example shown, the LSB is cleared to reserve the LSB location for the position marker. In another example, the two least significant bits in a bit block are cleared. In other examples, such as with 16-bit color, a larger number of significant bits may be cleared with position-marker mask 52. In effect, position-marker mask 52 operates on unmodified image data 50 to produce an even number as an intermediate result 54, resulting in a detectable cleared bit state when an image is scanned for a position marker. A cleared bit-block state with two or more least significant bits further increases the detectability of the scanner. The LSB or bit block may be cleared, for example, locally within each position marker perimeter, within the position markers and at a predefined guard band around each position marker, or across the entire image.

Intermediate result 54 is obtained by combining unmodified image data 50 with position-marker mask 52, such as with a bit-by-bit multiplication operation or with a logical AND operation on a bit-by-bit basis. A coded bit state 56 is added to intermediate result 54 to produce modified image data 58. Coded bit state 56 may be cleared or set, corresponding to a logical 0 or a logical 1 in the LSB position. Coded bit state 56, in this example, is set to a logical 1 in each color. For cases where position-marker mask 52 clears two or more least significant bits in a least significant bit block, the coded bit-block state may be a logical 1 or a logical 0 in the highest-order bit of the bit block, to provide the largest variation between a set and a cleared bit-block state in the written position-marker image. For example, in an eight-bit system, bit seven and bit eight are first cleared, then the coded bit-block may be a logical zero or one in bit-plane seven. The operations depicted may be repeated for each position-marker element and each position marker in the image.

The position markers are coded using one of many suitable coding schemes. In one example that uses a pixel-based coordinate system with an image size of 1000 by 1200 pixels, the position marker is coded with an x and a y coordinate corresponding to the distance from the upper left corner of the electronic paint surface. In another example, the position marker is coded with x and y coordinates corresponding to the number of writable elements from the lower left corner of the electronic paint surface. In yet another example, the position markers are assigned codes that have redundancy, have error-detection capability, or are self-correcting, with the location information for each coded position marker being generated and stored in a look-up table, or decoded using a suitable decoding algorithm.

FIG. 5 shows a block diagram of a system for activating an electronic paint, in accordance with one embodiment of the present invention. The paint activation system includes an electronic brush 30 having an electronic-paint activation device 34 and an electronic-brush scanner 36. Electronic-paint activation device 34 and electronic-brush scanner 36 are electrically connected and in electrical communication with a controller 38. Controller 38 may be wired or wirelessly connected to electronic-paint activation device 34 and electronic-brush scanner 36. Electronic-brush scanner 36 may scan for one or more embedded position markers in a first written portion of an electronic paint to determine position, location and rotation information of electronic brush 30. Controller 38 executing instructions stored in a memory 46 may determine the position of electronic brush 30 based on the scanned position markers. Memory 46 may also be used to store image data that is to be written onto the electronic paint. Controller 38 in conjunction with memory 46 may modify the image data to embed position markers in a second, unwritten portion of the image based on the determined position of electronic brush 30. Electronic-paint activation device 34 is used to write image data with embedded position markers onto the electronic paint.

The paint activation system allows the perimeters of the embedded position markers to be determined, based on the codes selected for inclusion within the position markers. When the selected codes contain orientation information, the paint activation system can read these codes and determine orientation of the embedded position markers.

FIG. 6 is a flow chart of a method for activating an electronic paint, in accordance with one embodiment of the present invention. The method includes various steps to write embedded position markers onto an electronic paint and to read the written position markers, which help determine the location and rotation of an electronic brush so that additional strokes of the brush can fill in unwritten portions of the image.

A first portion of an image including at least one embedded position marker is written onto a first portion of an electronic paint, as seen at block 80. An electronic brush including an electronic-paint activation device is used to write the first portion of the image. Accurate writing of the first portion of the image with the first position markers may be aided by the inclusion of, for example, a reference point on the electronic paint or on a frame around the electronic paint, a set of position markers permanently disposed in at least a portion of the electronic paint, a mechanical guide, or other suitable registration mechanism. From this initial portion, position markers are added as the image is written.

As the electronic brush is stroked across the electronic paint surface, the embedded position markers previously written onto the electronic paint are scanned, as seen at block 82. After scanning a first embedded position marker in a first, written portion of an image, the perimeter of the embedded position marker may be determined, and depending on the codes selected for the position markers, an orientation of the position marker may also be determined. From the information extracted from the scanned position markers on the written portion of the electronic paint, the position of the electronic brush is determined.

For example, the position of the electronic brush may be determined by comparing the scanned position markers to unmodified image data using pattern recognition techniques, and then determining the position of the electronic brush based on the comparison. In another example, the position of the electronic brush may be determined by determining a plurality of position-marker elements within a first embedded position marker, determining a position-marker element state for each position-marker element within the first embedded position marker, and then determining a marker position associated with the first embedded position marker based on the determined position-marker element states. A lookup table stored in memory is used, for example, to translate the coded position marker information into location coordinates, and location coordinates into position marker information. A lookup table is not necessary, for example, when coordinate data in binary form is written into the position marker. For instance, when reading from upper left to lower right in a 5×5 array of position marker elements, the first ten bits code the absolute x coordinate, the next ten bits code the y coordinate, and the remaining five bits form a redundant or an error-correcting code.

A plurality of embedded position markers in the first, written portion of the image is scanned and a rotation of the electronic brush may be determined based on the scanned position markers, as seen at block 84. Electronic brush rotation may be determined, for example, from adjacent position markers or from position markers that are further apart yet within range of the electronic-paint scanner. Increased accuracy in rotation determination may be achieved with two spaced-apart scanners. Alternatively, electronic brush rotation may be determined from orientation information embedded with the position marker.

Image data is modified to embed a second and additional position markers in a second, unwritten portion of the image based on the determined position of the electronic brush, as seen at block 86. Image data may be modified to embed the coded position information within the position markers in one initial operation on image data or interactively as the image is being written. In either case, the image information may be provided real-time as the image is written with the electronic brush or stored within the electronic brush until written.

In one example, the image data is modified by manipulating at least one image pixel in a position marked region in the second portion of the image, thereby embedding the second position marker in the unwritten portion of the image. At least one image pixel is manipulated by clearing a least significant bit within the position marked region and setting a coded bit state within the cleared position marked region based on a position-marker location. Alternatively, at least one image pixel is manipulated by clearing a least significant bit block of two or more least significant bits within the position marked region and setting a coded bit-block state within the cleared position marked region based on a position-marker location.

In another example, the image data is modified to embed the second position marker in the unwritten portion of the image by determining a position-marker element state for a plurality of position-marker elements within the second position marker, and adjusting the image data based on the position-marker element states.

In another example, the image data is modified to embed the second position marker in the second portion of the image by determining a position-marker element state for a plurality of position-marker elements within the second position marker, and adjusting the image data based on the position-marker element states and a position-marker mask.

The image data with the second and additional position markers is written onto a second, unwritten portion of the electronic paint, as seen at block 88. The scanning and position determination steps are repeated when additional portions of the image are written onto the electronic paint, as the electronic brush is moved across the surface of the electronic paint or is lifted from the surface and a new, semi-overlapping stroke is started, as seen at block 90.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of activating an electronic paint (10), comprising:
scanning a first embedded position marker (20) in a first portion (14) of an image (12) written onto a first portion of the electronic paint (10);
determining a position of an electronic brush (30) based on the scanned position marker (20);
modifying image data to embed a second position marker (26) in a second portion (16) of the image (12) based on the determined position of the electronic brush (30); and
writing the second portion (16) of the image (12) including the second position marker (26) onto a second portion of the electronic paint (10).

2. The method of claim 1 wherein determining the position of the electronic brush (30) includes comparing the scanned position marker (20) to unmodified image data, and determining the position of the electronic brush (30) based on the comparison.

3. The method of claim 1 wherein determining the position of the electronic brush (30) includes determining a plurality of position-marker elements (22) within the first embedded position marker (20), determining a position-marker element state for each position-marker element (22) within the first embedded position marker (20), and determining a marker position associated with the first embedded position marker (20) based on the position-marker element states.

4. The method of claim 1 wherein modifying the image data to embed the second position marker (26) in the second portion (16) of the image (12) includes manipulating at least one image pixel in a position marked region in the second portion (16) of the image (12).

5. The method of claim 4 wherein manipulating the at least one image pixel includes clearing a least significant bit within the position marked region and setting a coded bit state (56) within the cleared position marked region based on a position-marker location.

6. The method of claim 4 wherein manipulating the at least one image pixel includes clearing a least significant bit block within the position marked region and setting a
coded bit-block state within the cleared position marked region based on a position-marker location.

7. The method of claim 1 wherein modifying the image data to embed the second position marker (26) in the second portion (16) of the image (12) includes determining a position-marker element state for a plurality of position-marker elements (22) within the second position marker (26), and adjusting the image data based on the position-marker element states.

8. The method of claim 1 wherein modifying the image data to embed the second position marker (26) in the second portion (16) of the image (12) includes determining a position-marker element state for a plurality of position-marker elements (22) within the second position marker (26), and adjusting the image data based on the position-marker element states and a position-marker mask (52).

9. The method of claim 1 further comprising:
determining a perimeter (24) of the first embedded position marker (20).

10. The method of claim 1 further comprising:
determining an orientation of the first embedded position marker (20).

11. The method of claim 1 further comprising:
scanning a plurality of embedded position markers (20) in the first portion (14) of the image (12); and
determining a rotation of the electronic brush (30) based on the scanned plurality of embedded position markers (20).

12. The method of claim 1 further comprising:
writing the first portion (14) of the image (12) onto the first portion of the electronic paint (10), the first portion (14) of the image (12) including the first embedded position marker (20).

13. A system for activating an electronic paint (10), comprising:
means for scanning a first embedded position marker (20) in a first portion (14) of an image (12) written onto a first portion of the electronic paint (10);
means for determining a position of an electronic brush (30) based on the scanned position marker (20);
means for modifying image data to embed a second position marker (26) in a second portion (16) of the image (12) based on the determined position of the electronic brush (30); and
means for writing the second portion (16) of the image (12) with the second position marker (26) onto a second portion of the electronic paint (10).

14. The system of claim 13 further comprising:
means for determining a perimeter (24) of the first embedded position marker (20).

15. The system of claim 13 further comprising:
means for determining an orientation of the first embedded position marker (20).

16. The system of claim 13 further comprising:
means for scanning a plurality of embedded position markers (20) in the first portion (14) of the image (12); and
means for determining a rotation of the electronic brush (30) based on the scanned plurality of embedded position markers (20).

17. The system of claim 13 further comprising:
means for writing the first portion (14) of the image (12) onto the first portion of the electronic paint (10), wherein the first portion (14) of the image (12) includes the first embedded position marker (20).

18. An electronic brush (30) for activating an electronic paint (10), comprising:
an electronic-brush housing (32);
an electronic-paint activation device (34) coupled to the electronic-brush housing (32);
an electronic-brush scanner (36) coupled to the electronic-brush housing (32); and
a controller (38) in electrical communication with the electronic-paint activation device (34) and the electronic-brush scanner (36); wherein a position of the electronic brush (30) is determined based on at least one embedded position marker (20) in a first portion (14) of an image (12) written onto a first portion of electronic paint (10) that is scanned by the electronic-brush scanner (36) and communicated to the controller (38), and wherein an electronic-paint write signal is sent from the controller (38) to the electronic-paint activation device (34) based on the determined electronic-brush position.

19. The electronic brush of claim 18 wherein the controller (38) is wired or wirelessly connected to the electronic-paint activation device (34) and the electronic-brush scanner (36).

20. The electronic brush of claim 18 wherein the electronic-brush scanner (36) includes an optomechanical scanner or at least one imaging array.
